(19) United States
(12) Patent Application Publication
(10) Pub. No.: US 2009/0270831 A1
(43) Pub. Date: Oct. 29, 2009

(54) Cough Germ Containment Device

(76) Inventor: Ronald A. Mazzone, San Jose, CA (US)

Correspondence Address: QUICKPATENTS, INC., 32861 CALLE PERFECTO, SUITE A, SAN JUAN CAPISTRANO, CA, 92675, US

(21) Appl. No.: 12/108,077

(22) Filed: Apr. 23, 2008

(51) Int. Cl. A61J 1/18; A61J 1/05; F01N 5/00

(52) U.S. Cl. 604/404; 604/405; 181/211

(57) ABSTRACT

The present device is a suppression device for containing sound and germs emanating from a user's cough. A substantially hollow tube forms a gas conduit with a gas-permeable end membrane fixed within the tube across the gas conduit. A layer of a gas-permeable anti-bacterial material is fixed within the tube against the end membrane and a gas-permeable filter material is fixed within the tube against the anti-bacterial material. When a user needs to cough, the user coughs into the suppression device whereby the emanating germs and sound are suppressed as they encounter the filter material, the anti-bacterial material, and the end membrane. The suppression device further includes a lanyard permitting a user to wear the device and a label to write the user's name on the device. The suppression device is primarily comprised of biodegradable materials, allowing the suppression device to be disposable in an environmentally friendly way.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to germ containment, and more particularly to a cough germ and sound suppressor.

### DISCUSSION OF RELATED ART

Cough filters are well known in the art. For example, U.S. Pat. No. 6,986,348 to Carter on Jan. 17, 2006 teaches such a device. Such devices are made to either reduce the sound made from a cough or reduce the germs expelled from a cough or do both functions.

However, despite the development of many approaches to reduce the sounds of coughs and reduce the spreading of germs from coughs, these approaches often have significant drawbacks.

Some devices focus on just reducing the sound made from a cough. U.S. Pat. No. 6,085,864 to Copeland et al. on Jul. 11, 2000 teaches a cough muffler. U.S. Pat. No. 4,932,495 to Chapman on Jun. 12, 1990 teaches a vocal sound muffling device. U.S. Pat. No. 6,401,860 to Ellington et al. on Jun. 11, 2002 teaches a cough silencer device. All these devices are designed for hunters to avoid frightening animals when coughing or sneezing. However, none of these devices are concerned about controlling the spread of germs. These devices are designed to be used outdoors away from other humans and the spreading of germs from the cough is not a concern. Therefore, a device is needed that not only reduces the sound of a cough but also is specifically designed to reduce the spreading of germs.

U.S. Pat. No. 3,719,188 to Fisher et al. on Mar. 6, 1973 teaches a cough filter that is specifically designed to control the spreading of germs from a cough. However, this device is not specifically designed to minimize the disrupting sound of a cough. Also, the Fisher device does not teach the use of anti-bacterial material to further minimize the spreading of germs. Therefore, a device is needed that is designed for both reducing the spread of germs from a cough and also reducing the sound of a cough.

U.S. Pat. No. 6,986,348 to Carter on Jan. 17, 2006 teaches a germ and noise filter device.

This provides the advantage of having one device specifically designed to reduce both the germs and sounds from a human cough. Though, the Carter device teaches a disposable device, the structure of the Carter device is complicated design and teaches using plastic housing. Also, the Carter device teaches using micro-filters but does not teach using anti-bacterial material. Nor does the Carter device teach the hygienic and environmental benefits of using a disposable biodegradable device. Therefore, a device is needed that uses a simpler and more economical structure to reduce the cost of the device. A device is further needed that includes the benefits of using anti-bacterial material in addition to the benefits of using a filter material. Finally, a device is needed that uses biodegradable materials to make a more environmentally friendly disposable device so that a user is willing to replace the device often, which will improve the hygienic benefits of using the device.

Therefore, there is a need for a device that suppresses the sound of a cough but also is specifically designed to suppress the spreading of germs. Such a needed device would use a simple and economical structure to reduce the cost of the device. Further, the device would include the benefits of using anti-bacterial material in addition to the benefits of using a filter material. Finally, a device is needed that is disposable and uses biodegradable materials to be environmentally friendly. The present invention accomplishes these objectives.

### SUMMARY OF THE INVENTION

The present device is a suppression device for containing sound and germs emanating from a user's cough. A substantially hollow tube has an open proximal end and an open distal end, thereby forming a gas conduit. A gas-permeable end membrane is fixed within the tube across the gas conduit. A layer of a gas-permeable anti-bacterial material is fixed within the tube against a proximal side of the end membrane. A gas-permeable filter material is fixed within the tube against the anti-bacterial material, wherein the anti-bacterial material is located between the end membrane and the filter material.

In use, when a user needs to cough, the user places the proximal end of the hollow tube against the user's mouth. When the user coughs into the suppression device, the emanating germs and sound are suppressed as they encounter the filter material, the anti-bacterial material, and the end membrane. In addition to the suppression device preventing germs from exiting out of the tube, the device also acts to kill bacteria that contact the anti-bacterial material.

The suppression device further includes a lanyard fixed to opposing sides of the tube proximate the proximal end thereof, permitting a user to wear the suppression device for convenient and quick access to the suppression device. The suppression device further includes a label adapted to receive writing thereon and attachable to an outer surface of the tube. The label allows the user to write the user's name on the label and indicate that a particular suppression device is being used by the user, avoiding unhygienic contact by other persons. In a preferred embodiment, the suppression device is primarily comprised of biodegradable materials, allowing the suppression device to be disposable in an environmentally friendly way.

The present invention is a device that reduces the sound of a cough but also is specifically designed to reduce the spreading of germs. The device uses a simple and economical structure to reduce the cost of the device. Further, the present invention includes the benefits of using anti-bacterial material in addition to the benefits of using a filter material. Finally, the invention is disposable and uses biodegradable materials to be environmentally friendly. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is an exploded perspective view of the invention, illustrating components of the invention;

FIG. 2 is a partially cut-away perspective view of the invention, illustrating the relative placement of an end membrane, anti-bacterial material, and a filter material; and

FIG. 3 is a perspective view of the invention in use.

### DETAILED DESCRIPTION OF THE PREFERRED EMBODIMENT

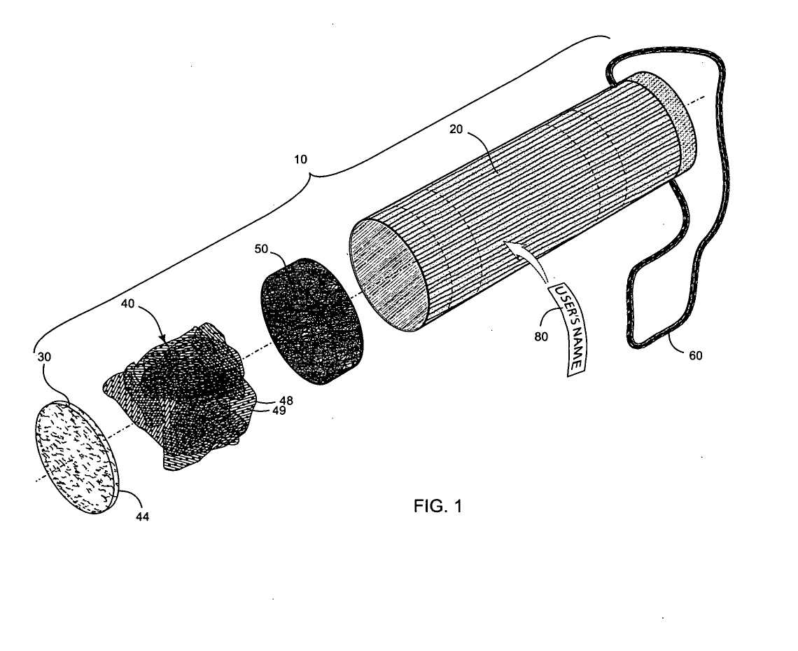

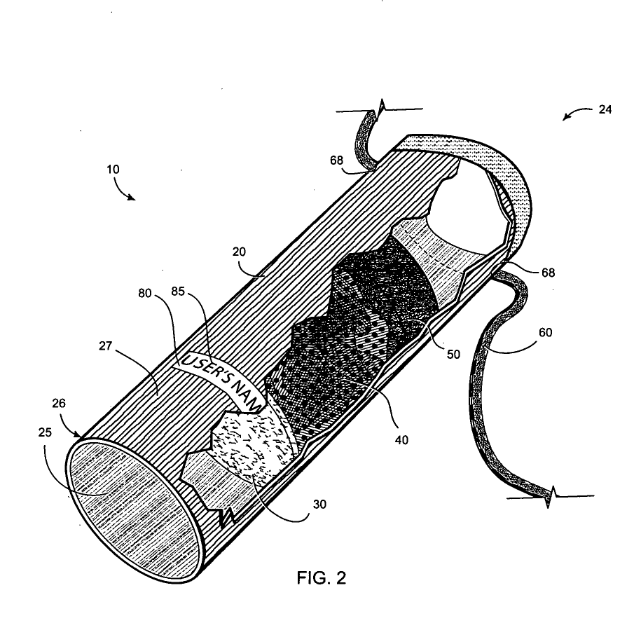

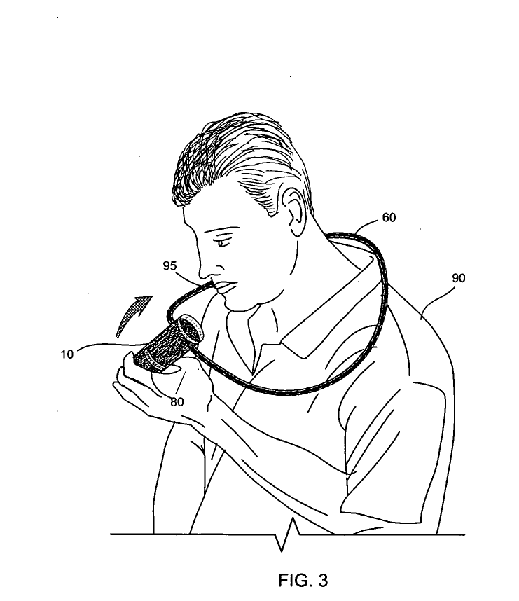

With respect to the drawings, FIG. 3 illustrates a suppression device 10 for containing sound and germs emanating from a user's 90 cough. In FIG. 2, a substantially hollow tube 20 has an open proximal end 24 and an open distal end 26, thereby forming a gas conduit 25. In FIGS. 1 and 2, a gas-permeable end membrane 30 is fixed within the tube 20 across the gas conduit 25. In one embodiment, the end membrane 30 is a web of flexible nylon.

In FIGS. 1 and 2, a layer of a gas-permeable anti-bacterial material 40 is fixed within the tube 20 against a proximal side 34 of the end membrane 30. In one embodiment illustrated in FIG. 1, the anti-bacterial material 40 is a fibrous material 48 having an anti-bacterial agent 49 interspersed therein.

In FIGS. 1 and 2, a gas-permeable filter material 50 is fixed within the tube 20 against the anti-bacterial material 40, wherein the anti-bacterial material 40 is located between the end membrane 30 and the filter material 50. In a preferred embodiment, the filter material 50 is a layer of cotton fibers. In use, when a user 90 needs to cough, the user 90 places the proximal end 24 of the hollow tube 20 against the user's mouth 95, as indicated in FIG. 3. When the user 90 coughs into the suppression device 10, the emanating germs and sound are suppressed as they pass through the filter material 50, the anti-bacterial material 40, and the end membrane 30. In addition to the suppression device 10 preventing germs from exiting out of the tube 20, the device 10 also acts to kill bacteria that encounter the anti-bacterial material 40.

In the embodiment illustrated in FIG. 2, the suppression device 10 further includes a lanyard 60 fixed to opposing sides 68 of the tube 20 proximate the proximal end 24 thereof. In one embodiment, the lanyard 60 is a cotton string material. The lanyard 60 permits a user 90 to wear the suppression device 10 providing convenient and quick access to the suppression device 10. In the embodiment illustrated in FIG. 2, the suppression device 10 further includes a label 80 adapted to receive writing 85 thereon and attachable to an outer surface 27 of the tube 20. The label 80 allows the user 90 to write the user's name on the label 80 and attach the label 80 to the tube 20, thereby indicating that a particular suppression device 10 is being used by the user 90.

In one embodiment, the tube 20 is comprised of a paper material. In another embodiment, the suppression device 10 is primarily comprised of biodegradable materials, such as paper and cotton based materials, allowing the suppression device 10 to be disposable in an environmentally friendly way. A disposable version of the suppression device 10 provides the advantage of a hygienic disposal method after the suppression device 10 has been used by a user 90, without the need to take apart the different parts of the device.

While a particular form of the invention has been illustrated and described, it will be apparent that various modifications can be made without departing from the spirit and scope of the invention. For example, the invention could include additional filtering layers to provide additional sound and germ suppression. Also, the outer surface 27 could include attractive decorative designs or the label 80 can be integrated with the outer surface 27. Accordingly, it is not intended that the invention be limited, except as by the appended claims.

What is claimed is:

1. A suppression device for containing sound and germs emanating from a user's cough, comprising:
a substantially hollow tube having open proximal and distal ends, a gas conduit being formed thereby, a gas-permeable end membrane fixed within the tube across the gas conduit;
a layer of a gas-permeable anti-bacterial material fixed within the tube against a proximal side of the end membrane; and
a gas-permeable filter material fixed within the tube against the anti-bacterial material.

2. The suppression device of claim 1 wherein the end membrane is a web of flexible nylon.

3. The suppression device of claim 1 wherein the anti-bacterial material is a fibrous material having an anti-bacterial agent interspersed therein.

4. The suppression device of claim 1 wherein the filter material is a layer of cotton fibers.

5. The suppression device of claim 1 further including a lanyard fixed to opposing sides of the tube proximate the proximal end thereof.

6. The suppression device of claim 1 wherein the suppression device further includes a label adapted to receive writing thereon and attachable to an outer surface of the tube.

7. The suppression device of claim 1 wherein the tube is comprised of a paper material.

8. The suppression device of claim 1 wherein the suppression device is primarily comprised of biodegradable materials.
